(19) United States
(12) Patent Application Publication
(10) Pub. No.: US 2020/0259663 A1
(43) Pub. Date: Aug. 13, 2020

(54) One-Time Data Signature System and Method with Untrusted Server Assistance

(71) Applicant: Guardtime SA, Lausanne (CH)

(72) Inventor: Denis FIRSOV, Tallinn (EE)

(73) Assignee: Guardtime SA, Lausanne (CH)

(21) Appl. No.: 16/784,561

(22) Filed: Feb. 7, 2020

Related U.S. Application Data
(60) Provisional application No. 62/802,462, filed on Feb. 7, 2019.

(51) Int. Cl. H04L 9/32; H04L 9/30; H04L 9/08; G06Q 10/10

(52) U.S. Cl. CPC H04L 9/3247; H04L 9/30; H04L 9/3236; H04L 9/3297; G06Q 10/1093; H04L 9/321; H04L 9/0872; H04L 2209/38; H04L 9/088

(57) ABSTRACT

To digitally sign a message, a signing entity generates a set of secret keys is generated and, for each secret key, a signing key is derived. An authenticator value is submitted to a signature server and is formed as a cryptographic binding of both the message and a respective one of the signing keys. The signature server then generates and returns to the signing entity a first signature of the authenticator value. If the signing entity determine that the first signature is valid, it replaces the signing key within the first signature with the secret key from which it was derived to form an augmented signature, and only thereafter reveals the respective secret key. This allows the signing entity to offload computational burden onto even an untrusted signature server.

### CROSS-REFERENCE TO RELATED APPLICATIONS

This application claims priority of U.S. Provisional Patent Application No. 62/802,462, filed 7 Feb. 2019.

### FIELD OF THE INVENTION

This invention relates to data security through the use of digital signatures.

### BACKGROUND

### Server-Based and Interactive Signature Systems

Many different forms of server-based and interactive signature systems exist. One example is the so-called On-line/Offline Signature system (OOS) proposed by Even, Goldreich and Micali in order to speed up the signature creation procedure, which is usually much more time-consuming than verification. The so-called Server-Supported Signatures (SSS) of Asokan, Tsudik, and Waidner delegate the use of time-consuming operations of asymmetric cryptography from clients (ordinary users) to a server. Clients may use hash chain authentication to send their messages to a signature server in an authenticated way and the server then creates a digital signature by using an ordinary public-key digital signature scheme. In SSS, signature servers are not assumed to be Trusted Third Parties (TTPs) because the transcript of the hash chain authentication phase can be used as evidence.

The so-called Delegate Servers (DS) proposed by, for example, Perrin, et al., reduce the problems and costs related to individual private keys. In their solution, clients (ordinary users) delegate their private cryptographic operations to a DS. Users authenticate to the DS and request to sign messages on their behalf by using the server's own private key. The main motivation behind DS was that private keys are difficult for ordinary users to use and easy for attackers to abuse. Private keys are not memorable like passwords or derivable from persons like biometrics and cannot easily be entered from keyboards like passwords. Private keys are mostly stored as files in computers or on smartcards, which may be stolen.

The main drawback in server-based signature solutions is that the server must be completely trusted. Still, it is somewhat unclear whether such a server-based signature system is less trustworthy than the traditional PKI (Public Key infrastructure) based signature solutions, where the signature keys are held by end-users. In fact, “average persons” creating electronic signatures may be compared to illiterate persons signing paper documents in the presence of a notary public. Indeed, the electronic devices generally used for creating electronic signatures are far more complicated than pens used to sign paper documents. Having full control over the electronic signature technology is out of the question for most users. Therefore, blind trust is inevitable in most electronic signature systems and it does not make much difference whether to trust one's personal computer or a signature server. Considering the limited knowledge average persons have about elementary security procedures, server-based solutions are preferable to the traditional ones.

The issue of trust is mitigated by server-supported signature schemes, where a signature is created in collaboration with both server and client, so that neither of the parties alone can create signatures. An example of such a scheme is “multiprime RSA”, where private key components are shared between a signer and a server. Server-supported signature schemes can realize several advantages:
Complete server-side logging of signing operations, so that in case of actual or suspected key leak the number of forged signatures is logged, making damage control and forensics manageable;
After key revocation, no signing is possible; thus, no new signatures can be created after the revocation, making key life cycle controls much simpler;
The server can add custom attributes, and even trusted attributes that cannot be forged by the server itself, for example, a cryptographic time-stamp, address, policy ID, etc.
The Server can perform necessary checks before participating in signing, for example, by performing a transaction validity check. Note that signed data does not have to be revealed to the server in normal cases.

Interactive signature protocols, based on interaction either between signer and verifier or with an external time-stamping service, have also been considered. In the “Guy Fawkes Protocol” proposed by R. J. Anderson, et al., once bootstrapped, a message is preceded by publishing the hash of the message, and each message is authenticated by accompanying it with a secret whose hash was published together with an earlier message. A broadcast commitment step is critical for providing non-repudiation of origin. Although the verification is limited to a single party, the protocol may be considered a signature scheme according to several definitions.

A similar concept in the context of authentication was first used in the TESLA protocol proposed by A. Perrig, et al.. TESLA was designed to authenticate parties who are constantly communicating with each other; thus, it has the same inflexibility as the Guy Fawkes protocol of not supporting multiple independent verifiers.

### Hash-Based Signatures

Other signature schemes have been proposed that are based on hash functions. Among the earliest digital signature schemes constructed from hash functions is due to Lamport. This is a one-time scheme and requires generation of a new key pair and distribution of a new public key for each message to be signed.

R. C. Merkle contributed the concept of a hash tree, which enables a large number of public keys to be represented by a single hash value. With the hash value published, any one of the N public keys can be shown to belong to the tree with a proof consisting of log₂N hash values, thus combining N instances of a one-time scheme into an N-time scheme. Buldas and Saarepera, and Coronado Garcia showed the aggregation to be secure if the hash function used to build the tree is collision resistant.

The current state of the art in hash-based signature schemes is represented by systems known as XMSS, SPHINCS, and the BLT system provided by Guardtime AS of Tallinn, Estonia.

### Authenticated Data Structures

An authenticated data structure is a data structure whose operations can be performed by an untrusted prover (server) and the integrity of results can be verified efficiently by a verifier. Authenticated data structures were first proposed for checking the correctness of computer memory and later analyzed in the context of tamper-evident logging. The concept found a practical use in PKI certificate management, first proposed by A. Buldas, P. Laud, and H. Lipmaa as “undeniable attesters”, where PKI users receive attestations of their certificates' inclusion or removal from a valid certificate database, and then the “certificate transparency” framework (B. Laurie, et al.), which facilitates public auditing of certification authority operations.

### Blockchain

Although the term “blockchain” itself, as well as related terms, do not yet have universally accepted definitions, typically a “blockchain” is understood as being a data structure comprising a series of usually (but not necessarily) cryptographically linked, time-stamped blocks, where each block includes data corresponding to one or more transactions, hashed together with linking data, such as the hash of some data and/or metadata of at least one preceding block. The blockchain can then be used to create a ledger, which is typically an append-only database.

Some blockchain variants involve distribution and consensus, that is, copies of the blockchain are distributed to several entities, which then follow a procedure to “agree” on what data is to be allowed to constitute the next block. Many of the blockchains used for cryptocurrencies follow this model, for example, since they, usually by design philosophy, wish to avoid any central authority. In other configurations, a single entity may control access to a proprietary blockchain according to its own rules; governments, banks, enterprises, etc., will, for example, usually not want the operation of their blockchains to depend on consensus among distributed, often anonymous outside entities. In either case, once data is entered into a block of the chain, the entry is essentially irrefutable, that is, non-repudiable, since any tampering with the data would be reflected in the chained hash calculations and thus easily detected.

One current point of dispute when it comes to the concept of a “blockchain” is whether, by definition, any entity may be allowed to submit blocks to and verify blocks in the blockchain, possibly only upon meeting some proof-of-work (such as Bitcoin's “mining”), or proof-of-stake requirement, or whether the entities that may submit to and verify blocks in the data structure must be permissioned by some central authority. In other words, there is dispute as to whether “blockchain” by definition implies “open” or not; the invention embodiments described below are not limited to any particular one of these definitions.

### BRIEF DESCRIPTION OF THE DRAWINGS

FIG. 1 illustrates the main entities and components of a “BLT” signature method and system.

FIG. 2 illustrates the main components and information exchange between components in some embodiments.

FIG. 3 illustrates a hash tree with indexed leaves.

FIG. 4 illustrates a t-th round of a server tree.

FIG. 5 shows the steps involved in the operation of an oracle that may be used in embodiments.

FIG. 6 illustrates a hash tree in which hashes of secret keys form some of the leaves.

### DESCRIPTION

Embodiments of this invention provide new methods, and corresponding system implementations, that are practical, provide forward security, non-repudiation of the origin, are resistant to known attacks even by quantum computers, and may even provide “built in” cryptographic time-stamping. The sizes of the signatures and keys, and their efficiency, are comparable with the state of the art of hash-based signature schemes. The new signature solutions are stateful, and the maximum number of signatures they create using a set of keys may be determined at the key-generation time.

### BLT Signature Scheme

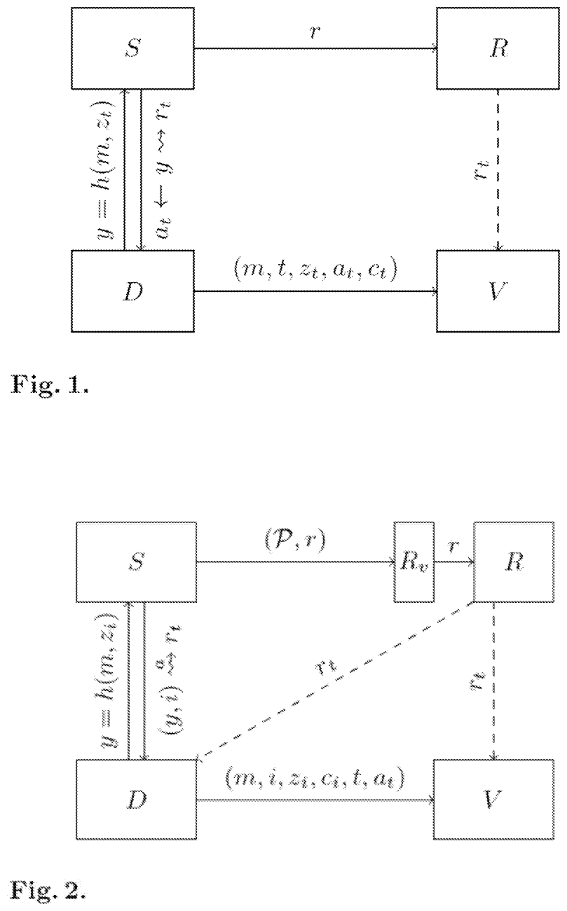

Some of the present inventors (Buldas, Laanoja, Truu) have themselves previously presented a hash-based solution—referred to as the “BLT” signature scheme—which depends on interaction with a time-stamping service. FIG. 1 illustrates the main entities and components of the BLT method and system: A Signer, who uses trusted functionality in a secure Device (D), at least one server (S), a Repository (R), and a Verifier (V). The principal idea of the BLT signature scheme is to have the signer commit to a sequence of secret keys. Each key is assigned a time epoch during which it can be used to sign messages and will transition from signing key to verification key once the epoch has passed. In order to prove timely usage of the keys, a cryptographic time-stamping service is used. It is possible to provide a suitable time-stamping service (see A. Buldas, A. Kroonmaa, and R. Laanoja, “Keyless signatures' infrastructure: How to build global distributed hash-trees”, NordSec 2013, Proceedings, volume 8208 of LNCS, pages 313-320. Springer, 2013) with no trust in the service provider (see . Buldas, R. Laanoja, P. Laud, and A. Truu, “Bounded pre-image awareness and the security of hash-tree keyless signatures”, ProvSec 2014, Proceedings, volume 8782 of LNCS, pages 130-145. Springer, 2014), using hash-linking and hash-then-publish schemes. Signing itself comprises time-stamping the message-key commitment in order to prove that the signing operation was performed at the correct time.

In more detail, in order to be able to sign messages at time epochs (1; . . . ; T), the Signer:
1) Generates T signing keys ( [symbol] ₁; . . . ; [symbol] _{T}), which may, for example, be unpredictable values drawn from {0; 1}^{k};
2) Binds each key to a respective epoch number: xᵢ←h(i; [symbol] ) for i∈{1; . . . ; T}, where h is a hash function; and
3) Computes the public key p by aggregating the key-epoch bindings into a hash tree: p←T^{h}(x₁; . . . ; x_{T}).
4) Let X˜c˜>Y denote that Y is the result of computation over a hash chain c with an input X. In the figures, “˜c˜>Y” is shown as a “curvy arrow” with the corresponding “c” over it. Where the chain is not specifically labeled, no “c” is indicated in the text or figures.

The resulting data structure is shown in FIG. 3 and its purpose is to be able to extract hash chains cᵢ linking the key-epoch bindings h(i; [symbol] ᵢ) to the public key p, that is, h(i; [symbol] ᵢ)˜cᵢ˜>p.

To sign a message m during epoch t, the signer:
1) Uses the appropriate key to authenticate the message: y←h(m; [symbol] ₜ).
2) Obtains a time-stamp on the authenticator y. It is preferred to use a hash-then-publish time-stamping service, in which case the time-stamp takes the form of a hash chain aₜ linking the authenticator y to rₜ, the root of the aggregation tree built by the server during the epoch t.
3) Outputs the tuple (t; [symbol] ₜ; cₜ; aₜ) as the signature.

Note that the signature is composed and emitted only after the verification of rₜ, which makes it safe for the signer to release the key [symbol] ₜ as part of the signature—the time-stamping service will already have closed the aggregation epoch t so that it's no longer possible to link new message authenticators to rₜ.

To verify that the message m and the signature s=(t; [symbol] ; c; a) match the public key p, the verifier:
1) Checks that [symbol] ₜ was committed as a signing key for time t: h(t; [symbol] )˜c˜>p.
2) Checks that m was authenticated with key [symbol] at time t: h(m; [symbol] )˜a˜>rₜ.

The BLT signature scheme thus uses one-time, time-bound keys, together with a cryptographic time-stamping service. It is post-quantum secure against known attacks and the integrity of a BLT signature does not depend on the secrecy of keys. The fact that keys have to be pre-generated for every possible signing epoch, for every signature, however, creates some implementation challenges, making, for example, on-smartcard key generation prohibitively slow in the case of real-world parameters.

### Guardtime® KSI® Blockchain

Embodiments of this invention do not require any specific form of time-stamping service, but a particularly advantageous form (based on the Guardtime infrastructure) is described below. In a preferred embodiment, the time-stamping is implemented using the data signature infrastructure developed and marketed under the name “KSI” by Guardtime AS of Tallinn, Estonia. This system is described in general in U.S. Pat No. 8,719,576 (also Buldas, et al., “Document verification with distributed calendar infrastructure”). In summary, for each of a sequence of calendar periods (typically related one-to-one with physical time units, such as one second), the Guardtime infrastructure takes digital input records as inputs, that is, lowest-level tree “leaves”. These are then cryptographically hashed together in an iterative, preferably binary hash tree, ultimately yielding an uppermost hash value (a “calendar value”) that encodes information in all the input records. This uppermost hash value is then entered into a “calendar”, which is structured as a form of blockchain which, in some implementations, may involve aggregating calendar values into a progressive hash tree. The KSI system then may return a signature in the form of a vector, including, among other data, the values of sibling nodes in the hash tree that enable recomputation of the respective calendar value if a purported copy of the corresponding original input record is in fact identical to the original input record.

As long as it is formatted according to specification, almost any set of data, including concatenations or other combinations of multiple input parameters, may be submitted as the digital input records, which do not even have to comprise the same parameters. One advantage of the KSI system is that each calendar block, and thus each signature generated in the respective calendar time period, has an irrefutable relationship to the time when the block was created. In other words, a KSI signature also acts as an irrefutable timestamp, since the signature itself encodes time to within the precision of the calendar period.

One other advantage of using a Guardtime infrastructure is that there is no need to store and maintain public/private (such as PKI) key pairs—the Guardtime system may be configured to be totally keyless except possibly for the purposes of identifying users or as temporary measures in some implementations in which calendar values are themselves combined in a hash tree structure for irrefutable publication. Another advantage is less apparent: Given the signature vector for a current, user-presented data record and knowledge of the hash function used in the hash tree, an entity will be able to verify (through hash computations as indicated by the signature vector) that a “candidate” record is correct even without having to access the signature/timestamping system at all.

Yet another advantage of the Guardtime infrastructure is that the digital input records that are submitted to the infrastructure for signature/timestamping do not need to be the “raw” data; rather, in most implementations, the raw data is optionally combined with any other desired input information (such as user ID, system information, various metadata, etc.) and then hashed. Given the nature of cryptographic hash functions, what gets input into the KSI system, and thus ultimately into the calendar blockchain, cannot be reconstructed from the hash, or from what is entered into the calendar blockchain.

### Blockchain-Backed BLT

In order to avoid the inherent inefficiency of pre-assigning individual keys to every time epoch, it would be advantageous if keys may be spent sequentially, one-by-one, as needed. This approach is particularly useful for real-world use cases where signing is performed in infrequent batches, for example, when paying monthly bills. Sequential key use needs more elaborate support from the server; in particular, it is necessary to keep track of spent keys by both the signer and the server, and to avoid successful re-use of the spent keys. Embodiments of the invention described herein manage these keys sequentially without placing too much trust in the server.

Embodiments of this invention, which improve on the basic BLT signature scheme, should preferably have as many of the following properties as possible:
The number of trusted components should be kept to a minimum, including minimization of trusted storage and computation, which may be offloaded to secure hardware or to a distributed cluster;
Forgery should be avoided as soon as possible, that is, it is better to avoid forgery at signing time so that a signature cannot be created at all, rather than creating a signature and requiring a verifier to detect the forgery. The least desirable option is not to be able to detect forgery until some later audit;
The amount of globally shared data should be minimal;
There should be a well-defined security model, assumptions, and root of trust;
Efficiency: many signers, few servers, single, shared root of trust;
Privacy by design. Even the fact that a signer has created a signature should preferably be known to the designated verifier(s) only; and
Easy to provide higher-level properties like non-repudiation, revocation, signing time.

Embodiments guarantee that reused one-time keys do not produce valid signatures. The previous BLT signature method employs time-bound keys, where every key can be used for signing at a specific point of time and no later. This incurs quite large overhead, however: Keys must be pre-generated even for time periods when no signatures are created. In contrast, the embodiments discussed below use keys sequentially, with server-side support—every signer has a designated server, which keeps track of spent keys, together with the signer, and does not allow creation of valid signatures using already spent keys.

One solution is to trust the server to behave honestly. In this case, the server maintains a spent key counter that is synchronized with the signer. The server then refuses to create signatures if key indexes do not match. One drawback of this solution is lack of non-repudiation—the server can collect spent keys and create valid signatures on behalf of the signer. This situation can be improved upon with trusted logging and auditing. Below, an embodiment is presented that addresses this problem of an untrusted signing server.

The signer may publish all signing events, including a key counter, in a public repository, such that the server cannot reuse keys and does not have to be treated as a trusted component. This approach will often be inefficient because of the amount of public, replicated data, which must be distributed and processed during verification; moreover, it leaks information about the signer's behavior. In this case, the public repository is like a component often called the “ledger” in literature relating to blockchains.

Embodiments described below avoid publishing all signing transactions, while not trusting the server. As a common feature, embodiments use spent key counters both at the signer side and server side; and the server periodically creates hash trees on top of its counters (i) and input hashes (y); and publishes root hashes to a public repository.

Assuming no collaboration between server and verifiers, the server cannot learn keys [symbol] ᵢ, and thus cannot produce valid signatures that depend on those keys. This may be difficult to enforce in practical implementations, however—one may normally assume that signatures can be published, and that the server has access to spent keys. With this restriction, a better method should eliminate the attack where the server decrements the spent key counter to i, signs a message using captured [symbol] ᵢ, and then increments the counter to its previous value.

Assuming the server and (other) signers do not cooperate maliciously, one solution is “neighborhood watch”: Signers observe changes in returned hash-chains and published roots and request proofs from the server that all changes were legitimate, by checking that key counters of signers assigned to neighboring leaves were incremented only. This approach detects forgeries but does not block them. A weakness of this approach is that it fails to deal with the possibility (or ever-present suspicion) of malicious cooperation between server and some of its clients.

The concept of authenticated data structures (see above) can be used for verifying the correct operation of the server. If the proof of correct operation is a part of signatures, then verifiers can reject signatures without valid proof and thus the server cannot forge signatures by tampering with the counters. This approach has quite large overhead: All potential verifiers must be able to validate all counters throughout their operational time. Other parties who can perform such validation are the Repository, the Signer, or an independent Auditor. Both Signer and Auditor could discover a forgery after the fact, but this will typically not be early enough to avoid creation of forged signatures.

In an embodiment, pre-validation is done by the Repository R, which may be implemented in a manner analogous to double-spending prevention performed by blockchains backing cryptographic currencies. In this case, Servers S should provide proofs of correct operation to the trusted Repository. The Repository may then publish a root hash only after validating the correct operation of the Servers. Published hashes may be made immutable using known cryptographic techniques and be widely distributed. Because signatures can be verified based only on the corresponding published root hash in the Repository, servers' forging of signatures by temporarily decrementing key usage counters can be eliminated. This solution is efficient since the blockchain (the amount of public data) grows only in linear relation to time; there is a relatively low number of trusted components; the blockchain, including its input validation is forward secure; the server's forgery attempts will be prevented at the signing time; and it is not necessary to have a long-term log of private data. The Repository may be implemented as a Byzantine fault tolerant distributed state machine, which eliminates the need to trust a single party. This embodiment will be described in more detail below.

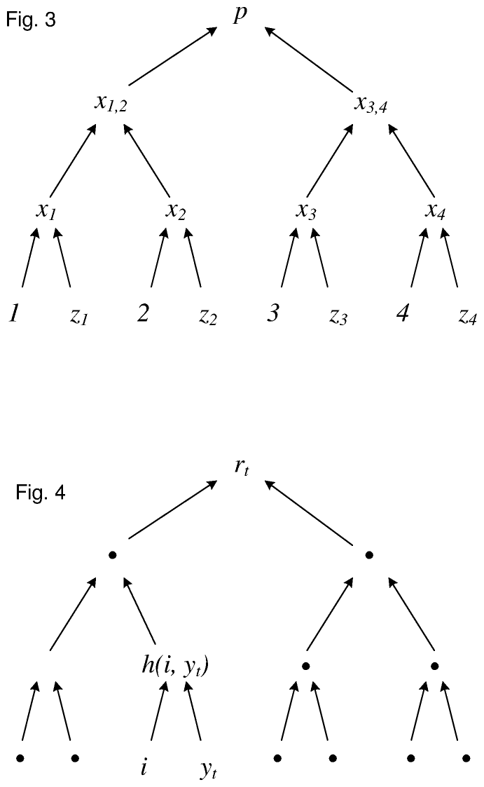

See now FIG. 2, which illustrates the main components and information exchange between the components in some embodiments:

Signer/Device D generates keys and then signs data.

Server S assists signers in generating signatures and keeps counters i of spent keys and publishes aggregate hashes to the Repository R. The correctness of operation of S may be verified by R before publishing.

S operates in rounds. It maintains a hash tree; there is one pre-assigned leaf for every signer client, indexed by j. A leaf lₜ=(iₜ; yₜ) for round t contains the tuple of the counter value and the last input query from the Signer. FIG. 4 illustrates, for example, a server tree for round t, depicting the key counter and input of the second client only.

S is allowed only to increment i; for every changed leaf it presents a proof P of correct operation to R. A proof consists of the value of the leaf in the previous round and hash chain leading to the root of previous round, previously published by R, the leaf value at current round, and the newly computed root of current round.

The Repository R performs two tasks. First (depicted as layer Rᵥ), it verifies the operation of S and after successful verification it commits the new root value r to a public append-only ledger or other irrefutable data structure.

The Verifier V is any relying party who wishes or needs to verify the signatures in any known manner. Described above is how Guardtime KSI signatures may be verified.

Keys may be generated in the same manner as in the basic BLT, although the number of keys required will typically be much smaller, and thus the generation process may be more efficient. In order to be able to sign N messages the Signer:
1) Generates N signing keys ( [symbol] ₁; . . . ; [symbol] _{N}), which may, for example, be unpredictable values drawn from {0; 1}^{k};
2) Binds each key to a respective sequence number: xᵢ←h(i; [symbol] ᵢ) for i∈{1; . . . ; N}, where h is a hash function; and
3) Computes the public key p by aggregating the key-index bindings into a hash tree: p←T^{h}(x₁; . . . ; x_{N}).

The resulting data structure (shown in FIG. 3) is the same as in case of basic BLT and its purpose is also the same: extracting the hash chains h(i; [symbol] ᵢ)˜cᵢ˜>p.

For signing, each Signer should keep its state, the sequence number i of next key. To sign a message in, the Signer:
1) Uses the next key to authenticate the message: y←h(m, [symbol] ᵢ).
2) Sends y to Server and receives membership proof aₜ that links the authenticator to the updated published root of the Server's hash tree: h(i; y)˜aₜ˜>rₜ.
3) Signer validates the Server's response using the authentic rₜ.
4) If validation succeeds, the Signer outputs the tuple (i; [symbol] ᵢ; cᵢ; t; aₜ), where i is the key sequence number, [symbol] ᵢ is the i-th signing key, cᵢ is the hash chain linking the binding of [symbol] ᵢ, and its sequence number i to the Signer's public key p, and aₜ is the hash chain returned by the Server linking the pair (i; y) to rₜ.

Finally, the Signer increments its spent key counter: i←i+1.

The Server S, upon receiving a request y, performs the following steps:
1) Collects requests from other clients until the end of the current aggregation round.
2) For each received request y, updates the leaf j for the client who made the query: iⱼ←iⱼ+1; lⱼ←(iⱼ; y).
3) Computes the updated hast tree root rₜ.
4) Submits the new rₜ to Repository R together with validity proof of every changed leaf: lₜ₋₁˜˜; lₜ˜˜>rₜ.
5) Upon receiving confirmation that rₜ is registered in the blockchain, returns hash chains aₜ to all clients with pending queries: pⱼ˜aₜ˜>rₜ.

Note that, as before, the signatures are composed and emitted only after the verification of rₜ, which makes it safe for the Signer to release the key [symbol] ᵢ as part of the signature—the server has already incremented its counter i so that only [symbol] ᵢ₊₁ could be used to produce the next valid signature.

The blockchain, which may be implemented in any entity, performs following operations:
1) Verifies the validity of every change in the Server's hash tree. For each update to the root must be a proof showing that this change was caused by a valid change of a leaf, where the key index was incremented;
2) Maintains cryptographic links between roots; and
3) Makes the roots publicly available.

To verify that the message in and the signature s=(i; [symbol] ; c; t; a) match the public key p, the Verifier:
1) Checks that [symbol] was committed as a signing key number i: h(i; [symbol] )˜c˜>p.
2) Checks that in was authenticated with key [symbol] at time t: h(i; h(m; [symbol] ))˜a˜>rₜ.
3) Checks that the value rₜ obtained in the previous step matches the one in the Repository.

The proofs of correct operation that the Server presents to the Repository can be constructed either iteratively, by generating hash chains before and after each leaf change, or in batches, taking hash chains before a round, applying all changes to leaves, generating a final Merkle tree, and then generating “after”-hash chains for each changed leaf. An iterative approach has the advantage that it is not necessary to perform explicit consistency and completeness checks between each leaf's chain.

Denote the sequence of indexes of leaf positions of clients who have provided a request during a round as a. Proof of correct operation of the round t may be defined as the sequence

[symbol]

ₜ=((i^{j}ₜ₋₁;y^{j}ₜ₋₁)a^{j}ₜ;(i^{j}ₜy^{j}ₜ):j= [symbol] ᵥ,v=(1; . . . ;| [symbol] |),

where (i^{j}ₜ; y^{j}ₜ) is the j-th leaf of the server hash tree in round t and a^{j}ₜ is the hash-chain from the leaf to the root. For the computation of the proof, the server tree is updated every time a leaf is changed (denoted by incrementing the in-round change counter v). Note that the content of the hash chain a^{j} does not change when the j-th leaf changes, because the rest of the leaves are still the same; this fact allows verification of the completeness of [symbol] and consistency of its elements by just verifying hash chains in the provided sequence, and checking that each “after”-root is the same as the “before”-root of the following change, checking the correctness and matching root of hash chains when computed in the same order.

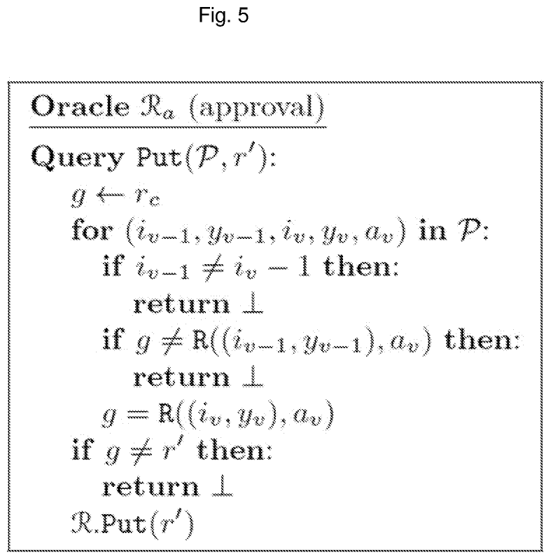

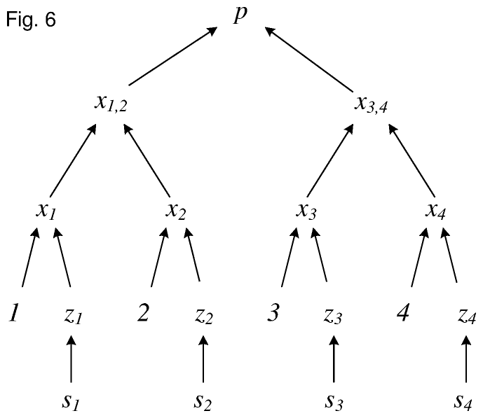

A verification routine for [symbol] is illustrated as the Oracle Rₐ in FIG. 5, where function R computes the hash tree root based on a leaf and a hash chain, so that r=R(l, a) if and only if l˜a˜>r.

### Delegated BLT

In this section of the disclosure, an embodiment is described that enables delegation of signing to an untrusted server. This extension to the basic BLT signature scheme described above allows a client to delegate the signing process to an untrusted server in such a way that the user will be able to verify what the server is signing before a valid signature is formed. This may be particularly relevant for the situations when the client has to produce signatures in an environment that is constrained, for example, by low computational power. To achieve that, the key generation, signing, and verification procedures are changed as follows.

To prepare to sign messages at time epochs (1; . . . ; T), the Signer:
1) Generates T secret keys (S₁; . . . ; s_{T}), which may, for example, be unpredictable values drawn from {0; 1}^{k}.
2) Derives T signing keys ( [symbol] ₁; . . . ; [symbol] _{T}): [symbol] ᵢ←f(i; sᵢ) for i∈{1; . . . ; T}, where f is a one-way function such as a hash function.
3) Binds each signing key to a respective sequence number: xᵢ←h(i; [symbol] ᵢ) for i∈{1; . . . ; T}, where h is, for example, a hash function.
4) Computes the public key p by aggregating the key-epoch bindings into a hash tree: p←T^{h}(x₁; . . . ; x_{T}).
5) Hands the signing keys [symbol] ᵢ and the public key p over to the Server but keeps the secret keys sᵢ strictly private.

The resulting data structure (shown in FIG. 6) now has two purposes: First, for each signing key the hash chain h(i; [symbol] ᵢ)˜cᵢ˜>p can be extracted; and second, for each signing key [symbol] ᵢ, the corresponding secret key sᵢ, when disclosed, can be verified via the relationship [symbol] ᵢ=f(i; sᵢ).

To have the Server sign a message m on its behalf, the Signer:
1) Uses the appropriate secret key to authenticate the message: y←h(m; sₜ).
2) Asks the Server to sign the authenticator y with the signing key [symbol] ₜ.
3) The Server returns a standard BLT signature sig' =(t, [symbol] ₜ, aₜ, cₜ).
4) The Signer verifies that sig' is a valid BLT signature on y.
5) If sig' is valid, the Signer replaces [symbol] ₜ with sₜ to obtain a complete augmented signature sig=(t, sₜ, aₜ, cₜ).

Note that, to authenticate the message m, this embodiment uses a secret key and not a signing key.

To verify that the message m and the augmented signature sig=(t; s; c; a) match the public key p, the verifier:
1) Checks that sₜ was committed as a secret key for time t: h(t; f(s))˜c˜>p.
2) Checks that m was authenticated with key s at time t: h(m; s) ˜a˜>rₜ.

This embodiment provides an extension to the basic BLT scheme that allows even a computationally weak user to delegate the signature-forming process to an untrusted server. The security of the described extension is based on the fact that the untrusted server produces only a “partial” signature sig=(t, [symbol] , a, c), which can be checked by the signer before completing the signing process. To complete the process, [symbol] , which acts as a token, is replaced with its pre-image s. Under standard cryptographic assumptions, this should be possible only by the signer who knows the original secret key s.

The solution provided by this embodiment may be compared with signature production methods that rely on zero-knowledge techniques. ZQL, for example, is a language for writing computations over hidden inputs. The disadvantage of the zero-knowledge approach is increased cryptographic and computational complexity, which results in performance penalties. In contrast, this “extended” BLT embodiment relies on well-known secure, yet easily computed hash functions.

We claim:

1. A method for digitally signing a message comprising:
generating a set of secret keys;
deriving signing keys as a function of respective ones of the secret keys;
submitting to a signature server an authenticator value formed as a cryptographic binding of both the message and a respective one of the signing keys, said signature server thereupon generating and returning to the signing entity a first signature of the authenticator value;
receiving the first signature from the signature server;
determining the validity of the first signature; and
if the first signature is determined to be valid, replacing within the first signature the signing key with the secret key from which the signing key was derived to form an augmented signature, and revealing the respective secret key.

2. The method of claim 1, further comprising:
generating the set of secret keys as a function of time, each secret key and its corresponding signing key being associated with a time; and
revealing the respective secret key only after its associated time has passed.

3. The method of claim 1, further comprising generating the set of secret keys and the signing keys as a function of a series index.

4. The method of claim 1, in which each signing key is derived as a cryptographic hash function with the respective secret key as an input parameter.

5. The method of claim 1, in which the cryptographic binding includes timestamping.

6. The method of claim 1, in which the first and augmented signatures comprise at least one hash chain leading to a respective hash tree root value.

7. The method of claim 1, further comprising computing a public key by inputting and aggregating the signing keys into a hash tree that has a root that forms a public key.

8. The method of claim 7, further comprising including respective time-associated values along with each respective signing key in the hash tree aggregation of the signing keys.

9. The method of claim 8, further comprising submitting the public key to the signing server along with the corresponding signing keys.

10. The method of claim 6, in which in which the first signature includes recomputation parameters and a calendar value corresponding to a calendar period during which the first signature was originally computed, such that an arbitrary subsequent test value is considered authenticated relative to the original inputted value if, using the recomputation parameters to logically recompute a hash tree path to the calendar value, which corresponds to the public key, the same calendar value is attained as when it was originally computed.

11. The method of claim 6, further comprising:
verifying that the secret key associated with the message was committed at a corresponding correct time by recomputing the corresponding hash chain to the root value associated with the secret key and that correct time; and
verifying that the message was authenticated at a corresponding correct time by recomputing the corresponding hash chain to the root value associated with the message and that correct time.
